(19) United States
(12) Patent Application Publication
(10) Pub. No.: US 2026/0366909 A1
(43) Pub. Date: Nov. 19, 2026

(54) DEVICE FOR MONITORING THE ASSEMBLY OF A COMPONENT, MONITORING SYSTEM AND ASSOCIATED METHOD

(71) Applicant: iNDTact GmbH, Würzburg (DE)

(72) Inventors: Raino PETRICEVIC, Würzburg (DE); Clemens LAUNER, Würzburg (DE)

(21) Appl. No.: 19/153,606

(22) PCT Filed: Feb. 8, 2024
(86) PCT No.: PCT/EP2024/053150

§ 371 Date: Aug. 5, 2025

(30) Foreign Application Priority Data
Feb. 9, 2023 (DE) 10 2023 103 150.3

(51) Int. Cl. G01H 1/00

(52) U.S. Cl. CPC G01H 1/00

(57) ABSTRACT

Device for monitoring the assembly of a component, having a structure-borne sound sensor which is designed to detect structure-borne sound and to generate a sensor signal which can be processed in a signal acquisition electronics, the structure-borne sound sensor being attached to a finger cap which can be plugged onto a finger of a user carrying out the assembly or can be plugged onto or stuck onto a gloved finger. In addition, a monitoring system and a method for monitoring the assembly of a component are described.

### RELATED APPLICATIONS

The present application is a National Phase of International Application Number PCT/EP 2024/053150 filed Feb. 8, 2024, and claims priority to German Application Number 10 2023 103 150.3 filed Feb. 9, 2023.

The invention relates to a device for monitoring the assembly of a component, having a structure-borne sound sensor which is designed to detect structure-borne sound and to generate a sensor signal which can be processed in a signal acquisition electronics.

In manual processes, for example in a plugging process, the component to be plugged in is gripped manually with the fingers or alternatively automatically with a gripper arm or a gripper hand. Such processes and activities can be recognized on the basis of their structure-borne sound intensity signature (time course) and spectral signature (frequency content) and evaluated in terms of completeness, origin and quality. This is best achieved if the signal is recorded with low interference and as little loss as possible with a certain resolution. This requires the widest possible sensitivity range in terms of frequency and dynamics.

A device for monitoring the assembly of a component is known from DE 103 08 403A 1 . There it is proposed to monitor the assembly of the component by means of a sound sensor that detects a sound signal generated during the assembly of the component. The sound signal is converted into a measurement signal, which is fed to an evaluation unit and evaluated there. A metallic insert in a glove is used as a sound bridge, which extends from a fingertip to the sound sensor, which is also integrated in the glove. However, such gloves, which have the sound sensor, wear out comparatively quickly, so that they sometimes have to be replaced after just a few hours. Since the sound sensor is permanently integrated into the glove, considerable costs are incurred for assembly monitoring due to the short service life.

The invention is therefore based on the task of providing a device for monitoring the assembly of a component that causes lower costs.

To solve this problem, in a device of the type mentioned above, it is provided that the structure-borne sound sensor is attached to a finger cap which can be plugged onto a finger of a user carrying out the assembly or can be plugged or stuck onto a gloved finger.

The invention is based on the idea that the useful life of a structure-borne sound sensor can be considerably increased if the structure-borne sound sensor is not permanently attached to or integrated into a glove. In this case, the same structure-borne sound sensor can be reused, for example when a glove to which the structure-borne sound sensor is attached needs to be replaced.

According to the invention, it is preferred that the structure-borne sound sensor can be detachably attached to the finger cap. In this case, the finger cap itself can also be exchanged and replaced, if necessary, without the structure-borne sound sensor also having to be replaced. If a finger cap is worn, only the finger cap is replaced and the same structure-borne sound sensor is attached to the new finger cap. A variant of the device according to the invention provides that electrical cables or conductor tracks, which are detachably or non-detachably connected to the sensor, can also be detachably attached to the glove. This means that the entire system integrated into the glove, apart from the fingertips, can be recycled or reused as wear parts. Ideally, the structure-borne sound sensor could be reused directly by simply placing it on the hand or glove. The detachable fixation could, for example, be achieved using a clamp connection or a Velcro fastener.

It is also possible for the structure-borne sound sensor to be arranged on or in a carrier that can be attached to the finger cap in a force-fit and/or form-fit and/or material-fit manner. The carrier can, for example, be designed as a frame which is positively connected to the finger cap. The structure-borne sound sensor itself can be connected to the frame or directly to the finger cap in a form-fitting manner.

In the context of the invention, it is preferred that the device has a plurality of structure-borne sound sensors which are attached to the same finger cap or to a plurality of finger caps, preferably with two or three structure-borne sound sensors which can preferably be operated simultaneously. In this case, several structure-borne sound sensors can be operated redundantly in parallel.

The device can then preferably generate a sensor signal that corresponds to the sum of the additively superimposed signals of the individual structure-borne sound sensors. In this way, a failure of a single structure-borne sound sensor can be compensated for.

Preferably, a coupling medium can be arranged between the finger cap and a structure-borne sound sensor, whereby the detachable coupling medium is preferably wax or a hot-melt adhesive. In this way, the acoustic and mechanical coupling between the structure-borne sound sensor and the surface of the finger cap is improved. If the finger cap is made of a textile material, it is also possible for the coupling medium to cover only one or more parts of the finger cap. Preferably, the detachable coupling medium allows the finger cap to be stretched. This enables adaptation to fingers of different sizes. The resulting improved impedance matching reduces signal losses. The coupling medium can also be designed as follows: as a framework made of a material that conducts structure-borne sound, for example a slightly thicker plastic material or metal filaments, as a monolithic framework made of a plastic material, as additional reinforcement using a knitted pattern. Alternatively or additionally, the coupling medium can also have an elastic material, for example hot-melt adhesive, silicone, polyurethane or rubber.

Preferably, the finger cap can be made of a textile material. Preferably, the finger cap can have air-permeable openings in the area of the fingertip. The air-permeable openings result from the texture or fabric structure of the textile material. This can be an abrasion-resistant fabric, for example aramid, with a woven-in metal or plastic filament.

The finger cap can also be tubular and have an opening for a fingertip. The tubular finger cap opened at the fingertip can also be made from an abrasion-resistant fabric such as aramid, which has a woven-in metal or plastic filament.

A coupling layer can also be provided on the finger cap in the area of the contact surface with the component to be mounted. When the component to be mounted is gripped, this coupling layer is elastically deformed so that it adapts locally to the component surface and can thus form a larger contact surface, i.e. a coupling surface for structure-borne sound with the component. The coupling surface can be created, for example, by impregnating a finger cap made of fabric, e.g. polyamide, aramid, polyester, etc., with or without the above-mentioned additional structure-borne sound-conducting filaments, with a rubber-elastic material, such as silicone, polyurethane or rubber. Preferably, this elastic coupling surface surrounds the entire outer finger cap surface. Preferably, the elastic coupling surface covers the edges of the finger cap so that no edges can be felt. For example, the edge transition to the glove can be completely smoothed out by tapered areas of the elastic layer protruding over the edges. The finger cap itself can consist of a hard plastic covered with a rubber-elastic plastic. However, the plastic cap can also consist entirely of a rubber-elastic plastic.

It is also possible for the finger cap to have one or more openings arranged in such a way that a user's finger is partially covered and partially exposed, with the area of a fingertip preferably being exposed. This design results in optimum structure-borne sound coupling between the object, for example a plug, and the structure-borne sound sensor with minimal restriction of fingertip sensitivity. The user can therefore touch the object directly, as the fingertip area is not covered.

The sound generated when mounting an object, such as a plug, is transmitted to the structure-borne sound sensor via the finger cap.

For ease of use, it may be provided that the structure-borne sound sensor and the signal acquisition electronics can be connected or are connected via an elastic electrical cable or lead, whereby the elastic elongation is preferably 5% to 20%. In addition, the evaluation unit can optionally also be connected to the signal acquisition electronics, e.g. via stretchable electrical cables. However, the evaluation unit is preferably coupled to the signal acquisition electronics via a wireless connection. The electrical cables can, for example, be laid or fixed on the back of the user's hand or in, on or to a glove, e.g. by means of an adhesive bond that can or cannot be removed. The electrical cables may also be attached to or in a preferably ergonomic and durable carrier device, i.e. a cable carrier, which is removably attachable to a hand or a glove. The adhesive bond can have a similar elastic elongation of between 5% and 20% as the stretchable electrical cable. Since the cable is preferably elastically stretchable, its length can stretch elastically like a spring when the user's hand and/or fingers are moved. The electrical cable can be designed as a twisted-pair cable and have one or more shielding cables. The electrical cable can have an elastically stretchable plastic as a carrier material for an electrically conductive material.

Alternatively, a tear-resistant wire, e.g. a steel wire, can be used as an electrical cable or conductor track. This can preferably be an insulated wire. The tear-resistant wire is preferably sewn onto a robust and skin-friendly textile carrier with a conductive filament for shielding. The ends of the tear-resistant wires, and possibly also the conductive filament, are connected to contacts on the sensor on the one hand and to contacts in a holder on the other. The sensor is connected via two electrodes and the shielding. The tear-resistant wires are preferably connected by splicing.

The sewn-in conductor tracks can also be located between two textile layers, a carrier layer and a cover layer. The cover layer can, for example, be glued onto the carrier layer.

For mechanical stabilization, a transition to the sensor element can be encapsulated in a casting compound, e.g. a hot-melt adhesive, which can either be removably reinserted into the polymer structure of the finger cap. Alternatively, the transition can also be permanently bonded to the finger cap using a hot-melt adhesive.

A preferred further development of the invention provides for the signal acquisition electronics to have an amplifier, an A/D converter, a signal processing unit and preferably a transmitting and receiving device. The signal acquisition electronics can, for example, be arranged on or on the hand of a user; alternatively, the signal acquisition electronics can be integrated into a glove. Preferably, the signal acquisition electronics can be connected to an ergonomic and durable carrier device, which also contains the electrical cables and can be detachably attached to a hand. The signal acquisition electronics function as a charge amplifier with adjustable filter characteristics and as an A/D converter as well as a ring buffer with high-pass triggering or band-pass triggering. The trigger is initiated by means of the digitally high-pass filtered signal or band-pass filtered signal, but the unfiltered digitized raw signal that lies within the trigger window is then sent. The charge amplifier improves the quality of the electronic signal, whereby an analog bandpass filter can preferably also be provided, which amplifies the weaker higher signal frequencies more than the lower ones, or amplifies signal frequencies in the usable frequency window and weakens and/or attenuates those beyond it. After converting the analog sensor signal of the structure-borne sound sensor in the A/D converter, the digital burst signal is transmitted to an internal or external evaluation unit where the signal processing takes place. The evaluation unit can differentiate whether the corresponding assembly process was carried out correctly or was faulty. Surprisingly, it is also possible to determine which of the various connectors has just been plugged in. This allows manual sequences to be recorded and the additional information obtained can be used to ensure seamless traceability.

The monitoring of electrical cable plugging processes is just one example of the application of the device according to the invention. It can also be used for other assembly processes, such as the plugging of cables, the insertion of clips or the assembly of snap-in mechanisms. What these processes have in common is that the assembly quality can be inferred from a recorded acoustic event. The device according to the invention can not only be used for manual processes, but can also be used for automated manufacturing processes, for example those carried out by a machine, a robot arm or a robot.

It is preferred that the signal acquisition electronics are arranged in a wristband that can be worn by the user. Such a wristband does not hinder the user in carrying out the assembly process.

It is particularly preferred that a receptacle for the signal acquisition electronics is provided so that the signal acquisition electronics can be detachably attached as a unit directly to the glove, e.g. in the area of the back of the hand.

For this purpose, a receptacle for the detachably attachable signal acquisition electronics is provided in or on the glove or in or on a carrier device (cable carrier) that can be detachably attached to a hand or a glove. This holder has the function of fixing the signal acquisition electronics and establishing electrical contact with the wiring and thus with the sensor elements; preferably, the holder can also be removed from the glove in order to recharge it and use it again after recharging.

Electrical contact can be made, for example, with the aid of plug connectors or by means of spring contacts on one side, e.g. on the side of the signal acquisition electronics, and contact surfaces or contact sockets on the other side, e.g. on the side of the receptacle. The receptacle is preferably connected to the glove or a carrier device (cable carrier) that can be attached to the glove or the hand in a force-fit and/or material-fit manner.

For its part, the receptacle is equipped with the corresponding electrical contact surfaces or contact points, whereby the receptacle establishes the connection to the structure-borne sound sensor via conductor tracks integrated in or applied to the glove or to or in a carrier device (cable carrier) that can be detachably attached to a hand or glove.

The housed signal acquisition electronics can be fastened in this holder by force and/or form-fit, e.g. via a detachable snap-in coupling. Preferably, it can also be attached using a magnetic catch. The holder is designed in such a way that the signal acquisition electronics can be easily removed but cannot fall out.

The invention also relates to a monitoring system with a transmitting and receiving device which is designed to communicate with a device of the type described, to evaluate information received from the device, which relates to an assembly process, in an evaluation unit and to send feedback to the device. The transmitting and receiving device serves as a central server or as a gateway connected to the central server, in which the information about evaluated assembly processes is collected. The transmitting and receiving device also has the function of evaluating the evaluated sensor signals and, in particular, determining whether a sensor signal is within a permissible range. The monitoring system comprises the central transmitting and receiving device and one or more devices for monitoring the assembly of a component. Several or many devices, each of which is worn by a user, can therefore be assigned to the central transmitting and receiving device.

The evaluation unit is preferably located in the monitoring system. However, it is also conceivable in principle that the evaluation unit can be located decentralized near the finger cap, for example in a glove or in or on a carrier device (cable carrier) that can be detachably attached to a hand or glove. In particular, the evaluation unit can be located together with the signal acquisition electronics in the same module housing. In this case, the evaluation unit would only send the information “OK” or “not OK” to the monitoring system. It may also be possible for the evaluation unit to send the detected type of plug to the monitoring system in addition to or as an alternative to “OK”.

The invention also relates to a method for monitoring the assembly of a component using a device of the type described and/or a monitoring system of the type described, wherein the device has a structure-borne sound sensor which is attached to a finger cap which is placed on a finger of a user carrying out the assembly or is placed on or glued to a gloved finger.

The device can have one or more structure-borne sound sensors. Similarly, the device may have one or more finger caps which can be slipped onto one or more fingers or which are slipped onto or adhered to one or more glove fingers.

According to the invention, it may be provided that the device generates a sensor signal which is composed of a plurality of superimposed signals from the individual structure-borne sound sensors.

A further development of the invention provides that the evaluation unit is designed to evaluate sensor signals on the basis of artificial neural networks.

Preferably, in the method according to the invention, the transmitting and receiving device can evaluate information received from a device relating to an assembly process and send feedback to the device. Preferably, the feedback can be output by the device as an acoustic and/or tactile and/or optical signal. In this way, the user receives immediate feedback as to whether an assembly process has been carried out correctly or not. If the assembly process was not correct, it can be repeated so that error-free assembly is possible.

The invention is explained below with reference to the figures by means of embodiments. The figures are schematic representations and show:

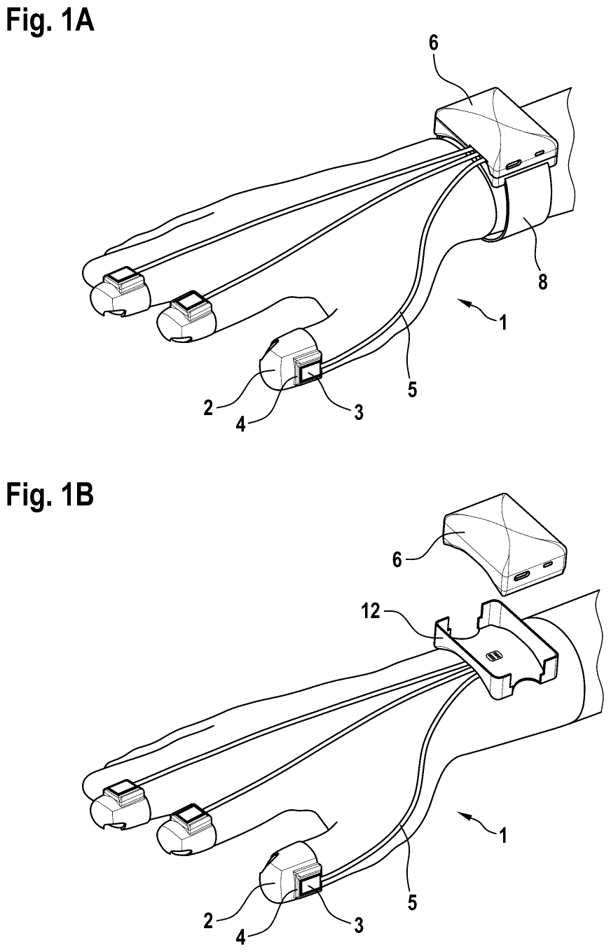

FIG. 1A a first embodiment of the invention with several devices according to the invention attached to a glove;

FIG. 1B a second embodiment of the invention;

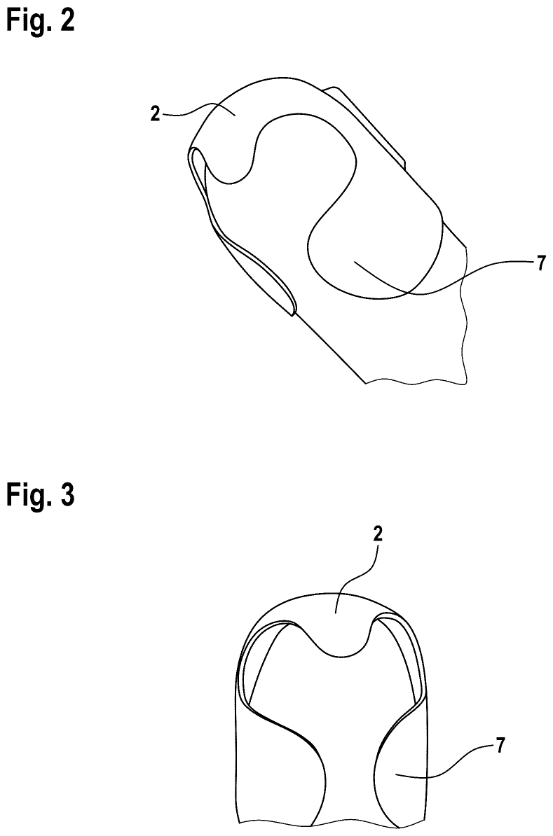

FIG. 2 a detail of a finger cap;

FIG. 3 a further view of the finger cap shown in FIG. 2;

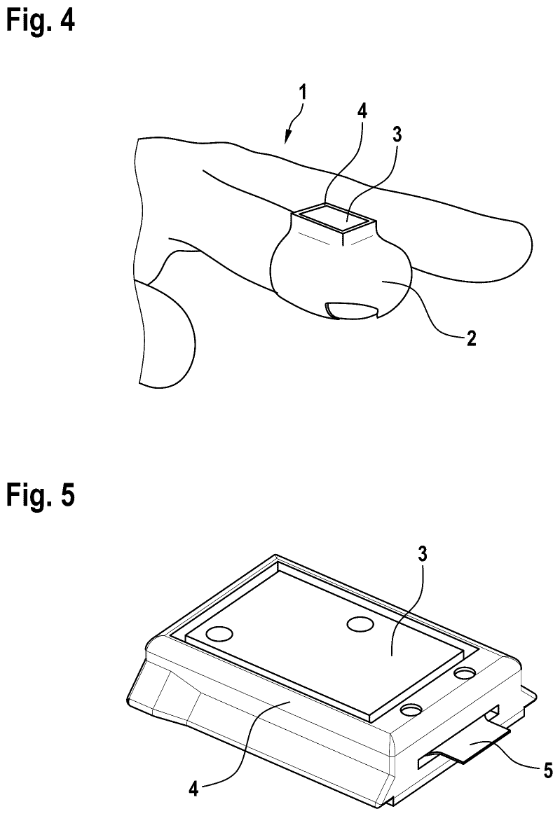

FIG. 4 a detail of a glove provided with a finger cap;

FIG. 5 a carrier with a structure-borne sound sensor;

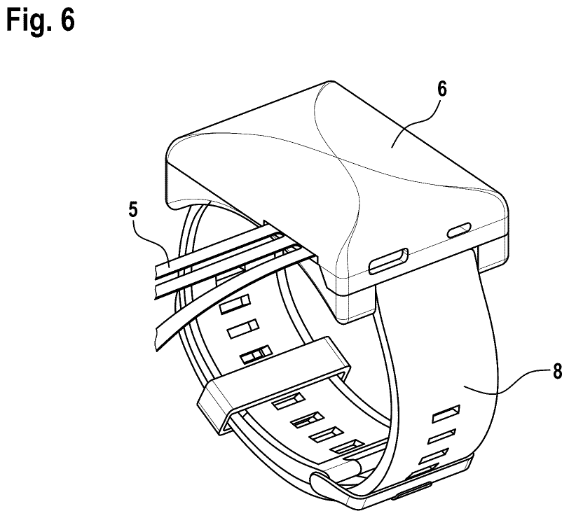

FIG. 6 the signal acquisition electronics attached to a wristband;

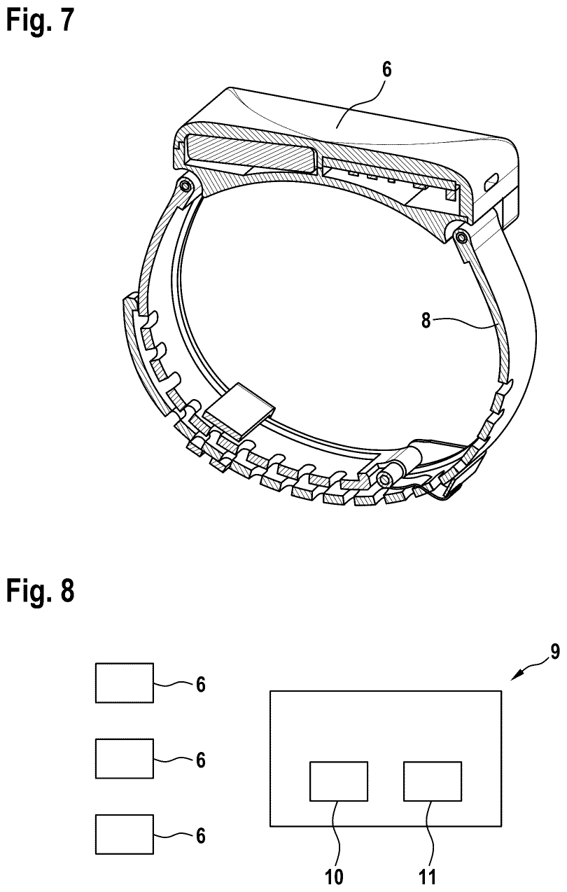

FIG. 7 a sectional view of the wristband shown in FIG. 6; and

FIG. 8 a schematic representation of a monitoring system according to the invention.

FIG. 1A is a perspective view and shows a glove 1 that can be slipped over the hand of a user. The glove 1 comprises a total of three finger caps 2 bonded to the glove 1, each of which partially covers the end section of a finger. Each finger cap 2 is provided with a structure-borne sound sensor 3, which is attached to a carrier 4. The carrier 4 has a frame to which the structure-borne sound sensor 3 can be attached detachably or non-detachably. The carrier 4 is attached to the finger cap 2 in a force-fit and/or form-fit manner. Each structure-borne sound sensor 3 is connected to signal acquisition electronics 6 via a flexible electrical cable 5. The cable 5 is elastically stretchable, the stretch can be between 5% and 20%, in the illustrated embodiment it is 10%. The cable 5 is also deformed accordingly when the user's hand or fingers move and can easily follow the movement. Since the cable 5 is made of an elastic material, the cable can return to its original size and shape after the end of a tensile load. In other embodiments, stretchable conductor tracks can also be used instead of cables. Such stretchable conductive tracks can be easily laid on the back of the user's hand or alternatively in a glove or in a removable carrier, which can be removably attached to the back of the hand or glove. The elastic cables or conductor tracks act like springs with a recovery effect, which automatically deform back again after a deflection. Elastic conductor tracks can consist of etched copper tracks or screen-printed electrically conductive conductor tracks, e.g. based on silver conductive paint or conductive polymer, which are attached to an elastic carrier material. For each structure-borne sound sensor, a bipolar signal conductor pair is laid in a meandering pattern in one or two planes to form a two-dimensional twisted-pair cable. However, expandable electrical cables can also run parallel and straight in one or two planes.

The glove 1 shown in FIG. 1A is optional; in principle, the device can also be used in such a way that one or more finger caps 2, on each of which there is a structure-borne sound sensor 3, are slipped over like a thimble and connected to the signal acquisition electronics 6 via the cables 5.

The signal acquisition electronics 6 are housed in a module housing that is attached to a wristband 8. The wristband 8 surrounds the user's wrist. The cables 5 are connected both to the structure-borne sound sensors 3 and to the signal acquisition electronics 6 via plug contacts.

FIG. 1B shows a similar embodiment like FIG. 1A, with corresponding components marked with the same reference symbols. The glove 1 has the finger caps 2 with the carriers 4 and the structure-borne sound sensors 3. Each structure-borne sound sensor 3 can be connected to a receptacle 12 for the removable signal acquisition electronics 6 via a cable 5. When the signal acquisition electronics 6 is inserted into the receptacle 12, it is electrically connected to the receptacle 12 via electrical contacts such as plugs, sockets, pins, etc. In contrast to the embodiment shown in FIG. 1A, the signal acquisition electronics 6 is arranged directly on the outside of the glove 1 via the receptacle 12. When the signal acquisition electronics 6 is inserted into the receptacle 12, it automatically goes into operation and is switched off when it is removed. The switched-on state is signaled by a corresponding light indicator.

FIGS. 2 and 3 show a detail of the finger cap 2, with FIG. 2 showing a perspective view and FIG. 3 showing the underside. The finger cap 2 comprises several rounded section 7 that extend to its underside. However, the underside of the finger is recessed, i.e. the section 7 have a continuous opening there and are exposed. This allows the user to feel an object, for example a plug or the like, with the underside of the finger without impairing the sense of touch. A corresponding assembly process, for example the insertion of a plug into a socket, can be tactilely monitored by the user. The design shown in FIG. 2 with three wing-like section 7 is merely an example.

Modifications are also possible in which, for example, only one or two lateral wing-like section 7 are present. The common feature of all versions is that the fingertip sensitivity is restricted as little as possible with maximum sound conductivity. Accordingly, the finger cap 2 is designed in the area of the fingertips in such a way that part of the finger cap 2 always touches the object directly when touching an object. Alternatively, indirect contact is also possible if the user is also wearing a glove.

FIG. 4 shows an enlarged view of the glove 1 fitted with the finger cap 2. The structure-borne sound sensor 3 attached to the carrier 4 is located on the top of the finger cap 2. The finger cap 2 is replaceable. It can be designed in such a way that it is held on the glove 1 by friction alone. However, it can also be attached to the glove 1 with an adhesive. The finger cap is attached in such a way that it cannot slip during assembly. It can be designed so that it can be removed, but it can also be attached to the glove in a non-detachable manner. Since the structure-borne sound sensor 3 is also detachably attached, it can be reused alone or together with the carrier 4. Accordingly, only the finger cap 2 is a wearing part. Replacing a finger cap 2 or the glove 1 with or without finger cap 2 can therefore be carried out easily and inexpensively. The expensive and therefore preferably replaceable components are the structure-borne sound sensor 3 with the cable and the signal acquisition electronics 6. The receptacle 12 is also preferably reusable. However, a carrier device not shown here for the electronics holder and cable or leads, which can be detachably attached to a hand or a glove, is also preferably reusable. The glove 1 and the finger cap 2 are wear parts and relatively inexpensive.

FIG. 5 shows the carrier 4 with the structure-borne sound sensor 3. The carrier 4, which can be attached to the finger cap 2, is essentially rectangular in shape. It has an opening for the plug-in cable 5, which connects the structure-borne sound sensor 3 to the signal acquisition electronics 6. On its upper side, the carrier 4 has a frame for snapping and/or gluing the structure-borne sound sensor 3 into position. There are electrical contacts on the underside of the structure-borne sound sensor 3, which are connected to opposite electrical contacts in the frame of the carrier 4 when the structure-borne sound sensor 3 is inserted into the carrier 4.

As the carrier 4 is attached directly to the finger cap 2, the transmission path for structure-borne sound is minimal. On the other hand, the signal yield is maximum. The signal that can be detected by the structure-borne sound sensor 3, for example when a plug is inserted into a socket, reaches the structure-borne sound sensor 3 with low losses and a wide bandwidth.

There is a contact surface between the carrier 4 with the snapped-in and/or glued-in structure-borne sound sensor 3 and the finger cap 2, which is enlarged by a comb-shaped or tooth-shaped interlocking surface structure. In this way, an impedance jump caused by an air gap is minimized. A coupling medium, which is wax or a hot-melt adhesive, is applied to the contact surface between the carrier 4 with the snapped-in and/or glued-in structure-borne sound sensor 3 and the finger cap 2. The coupling medium improves impedance matching, which reduces signal losses.

FIG. 6 shows the signal acquisition electronics 6 attached to a wristband 8. The wristband 8 can be worn like a watch strap. On the side of the module facing the fingers, in which the signal acquisition electronics 6 are located, the cables 5 provided with a plug open out, whereby the structure-borne sound sensors 3 are connected to the signal acquisition electronics 6. The wristband and cables can also take the form of a removable, attachable carrier device not shown here.

FIG. 7 is a similar view to FIG. 6 and shows the wristband 8 with the signal acquisition electronics 6 in a sectioned view. The signal acquisition electronics 6 comprises an amplifier, an A/D converter, a signal processing unit and a transmitting and receiving device. A rechargeable battery is also integrated. The amplifier is connected to an analog bandpass filter to increase the quality of the signal. The bandpass filter is designed in such a way that higher signal frequencies in the measuring range, which have a low amplitude, are amplified more than lower frequencies, which have a higher amplitude. The bandpass filter can be composed of various active and/or passive filters of first order or higher order. The amplifier and the bandpass filter are preferably designed in such a way that frequencies below the targeted useful signal and above the Nyquist frequency (half the sampling frequency) are attenuated to such an extent that neither clipping nor aliasing effects occur.

FIG. 8 schematically shows a monitoring system 9 with a transmitting and receiving device 10, which is designed to communicate with several devices of the type described at, each comprising signal acquisition electronics 6. The monitoring system 9 comprises an evaluation unit 11 in which information relating to an assembly process transmitted by one of the monitoring systems 9 is evaluated. The evaluation unit 11 determines whether the assembly process was carried out correctly. If it is determined that the assembly has not been carried out correctly, visual and/or acoustic and/or tactile feedback is given to the user so that he can correct or repeat the faulty assembly process. All assembly processes are stored by the evaluation unit 11 for documentation purposes. The sensor signals are evaluated on the basis of artificial neural networks.

### LIST OF REFERENCE NUMBERS

1 glove
2 finger cap
3 structure-borne sound sensor
4 carrier
5 cable
6 signal acquisition electronics
7 section
8 wristband
9 monitoring system
10 transmitting and receiving device
11 evaluation unit
12 receptacle

1. Device for monitoring the assembly of a component, having a structure-borne sound sensor which is designed to detect structure-borne sound and to generate a sensor signal which can be evaluated in a signal acquisition electronics, wherein the structure-borne sound sensor is attached to a finger cap which can be plugged onto a finger of a user carrying out the assembly or can be plugged onto or stuck onto a gloved finger.

2. Device according to claim 1, wherein the structure-borne sound sensor can be detachably attached to the finger cap.

3. Device according to claim 1, wherein the structure-borne sound sensor is arranged on or in a carrier which can be attached to the finger cap in a force-locking and/or form-locking manner.

4. Device according to claim 1, wherein the device comprises a plurality of structure-borne sound sensors which are attached to the same finger cap or to a plurality of finger caps, wherein preferably two or three structure-borne sound sensors are present, which further preferably can be operated simultaneously.

5. Device according to claim 4, wherein the device is designed to generate a sensor signal which is composed of a plurality of superimposed signals from the individual structure-borne sound sensors.

6. Device according to claim 1, wherein a coupling medium is arranged between the finger cap and a structure-borne sound sensor, wherein the coupling medium is preferably wax or a hot-melt adhesive.

7. Device according to claim 1, wherein the finger cap comprises one or more openings arranged such that a finger of a user is partially covered and partially exposed, wherein preferably the region of a fingertip is exposed.

8. Device according to claim 7, wherein the finger cap is made of a textile material and preferably has air-permeable openings in the area of the fingertip.

9. Device according to claim 7, wherein the finger cap is tubular and has an opening for a fingertip.

10. Device according to claim 1, wherein the structure-borne sound sensor and the signal acquisition electronics can be connected or are connected via a stretchable electrical cable, wherein the elastic elongation is preferably 5% to 20%.

11. Device according to claim 1, wherein the signal acquisition electronics comprises an amplifier, an A/D converter, a signal processing unit and preferably a transmitting and receiving device and/or a decentralized evaluation unit.

12. Device according to claim 1, wherein the signal acquisition electronics is detachably mountable in or on a wristband or in or on a glove or in or on a wearing device which is detachable from the wristband or from the glove and which also contains cables, and is preferably detachable for charging an energy storage device.

13. Monitoring system, with a transmitting and receiving device, which is designed to communicate with a device according to claim 1, to evaluate information received from the device, which relates to an assembly process, in an evaluation unit and to send feedback to the device.

14. Method for monitoring the assembly of a component with a device according to claim 1, wherein the device has a structure-borne sound sensor which detects structure-borne sound and generates a sensor signal which can be evaluated in a signal acquisition electronics, wherein the structure-borne sound sensor is attached to a finger cap which is plugged onto a finger of a user carrying out the assembly or can be plugged onto or stuck onto a gloved finger.

15. Method according to claim 14, wherein the device generates a sensor signal which is composed of a plurality of superimposed signals from the individual structure-borne sound sensors.

16. Method according to claim 14, wherein the signal acquisition electronics is designed to evaluate sensor signals on the basis of artificial neural networks.

17. Method according to claim 14, wherein a transmitting and receiving device evaluates information received from a device relating to an assembly process and sends feedback to the device.

18. Method according to claim 14, wherein the feedback sent by the transmitting and receiving device is output by the device as an acoustic and/or optical and/or tactile signal.
